(19) United States
(12) Patent Application Publication
(10) Pub. No.: US 2012/0311778 A1
(43) Pub. Date: Dec. 13, 2012

(54) COMBINATION BED AND BATHTUB

(76) Inventor: Sadie Dixon, Bolingbrook, IL (US)

(21) Appl. No.: 13/158,460

(22) Filed: Jun. 13, 2011

(51) Int. Cl. A61G 7/00

(52) U.S. Cl. 4/547

(57) ABSTRACT

The present invention is a combination bed and bathtub that includes a mattress with a left portion and a right portion and a bathtub with a bottom disposed below the mattress, where the left portion and the right portion are separated to utilize the bathtub. There is also a sponge pad disposed on the bottom of the bathtub and an electrically powered device to separate and retract the left portion and the right portion. The combination bed and bathtub can also be manually separated and retracted and the sponge pad is made of light and removable sponge padding. The combination bed and bathtub can be utilized in a hospital, a nursing home or by a caregiver.

### TECHNICAL FIELD & BACKGROUND

Caregivers afforded the task of bathing individuals may have difficulties transporting patients from their bed to the bathtub and vice versa. Currently there are no superior alternatives to conventional and current sleeping and bathing units that utilize a bed with a bathtub disposed directly underneath a bed.

The present invention generally relates to a bathtub. More specifically, the invention is a combination bed and bathtub.

It is an object of the invention to provide a combination bed and bathtub to facilitate the bathing process for those who cannot bathe themselves or get out of bed.

It is an object of the invention to provide a combination bed and bathtub for individuals that are disabled, handicapped or elderly, or that frequently find it difficult or impossible to properly bathe them.

What is really needed is a combination bed and bathtub to facilitate the bathing process for those who cannot bathe themselves or get out of bed and for individuals that are disabled, handicapped or elderly, or that frequently finds it difficult or impossible to properly bathe them.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates an overhead perspective view of a mattress of a combination bed and bathtub, in accordance with one embodiment of the present invention.

FIG. 1B illustrates an overhead perspective view of a mattress of a combination bed and bathtub, in accordance with one embodiment of the present invention.

FIG. 1C illustrates an overhead perspective view of a mattress and a sponge pad of a combination bed and bathtub, in accordance with one embodiment of the present invention.

FIG. 1D illustrates a side perspective view of a combination bed and bathtub, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

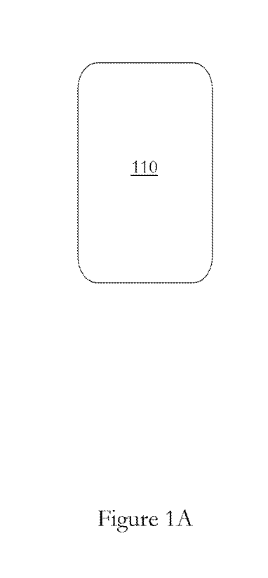

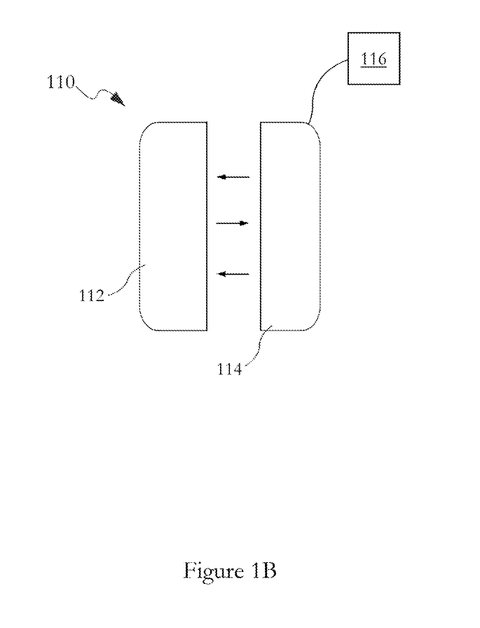

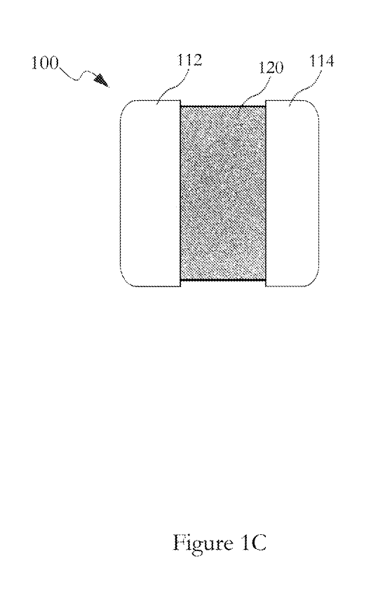

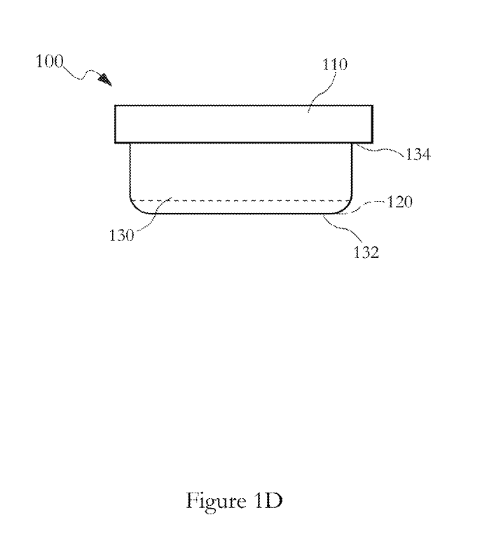

FIG. 1A illustrates an overhead perspective view of a mattress 110 of a combination bed and bathtub 100, in accordance with one embodiment of the present invention. The mattress 110 can be any type of suitable mattress that can be separated to accommodate a user. Details regarding the mattress 110 are described in FIG. 1B and its description.

FIG. 1B illustrates an overhead perspective view of a mattress 110 of a combination bed and bathtub 100, in accordance with one embodiment of the present invention. The mattress 110 can be divided into a left portion 112 and a right portion 114 which can be separated to accommodate a user (not shown). The mattress 110 can also be retracted together after being separated forming a single cohesive mattress. The mattress 110 can be separated and retracted manually or with an electrically powered device 116.

FIG. 1C illustrates an overhead perspective view of a mattress 110 and a sponge pad 120 of a combination bed and bathtub 100, in accordance with one embodiment of the present invention. The combination bed and bathtub 100 includes a sponge pad 120. The sponge pad 120 is exposed when the left portion 112 and the right portion 114 of the mattress 110 are separated.

FIG. 1D illustrates a side perspective view of a combination bed and bathtub 100, in accordance with one embodiment of the present invention. The combination bed and bathtub 100 includes a bathtub 130 that can be utilized to wash a user as needed. The sponge pad 120 described in FIG. 1C is disposed on a bottom 132 of the bathtub. The mattress 110 is disposed on top 134 of the bathtub which can be utilized when the left portion 112 and the right portion 114 of the mattress 110 are separated.

The combination bed and bathtub is convenient and easy to operate. When a user needs to be bathed, the mattress automatically separates through the middle manually or with an electrically powered device exposing a layer of light and removable sponge padding. The individual is then gently lowered directly into the bathtub and can utilize the bathtub as desired. When the user's bath is complete, the user is comfortably lifted slightly above the bed level, where the mattress will join together again, allowing the user to be lowered onto it. The combination bed and bathtub is designed in three different models which include a single hospital model, a double size bed model and a deluxe model. The combination bed and bathtub is useful and secure and can be utilized by hospitals, nursing homes and caregivers.

The combination bed and bathtub combines the functions of both a bed and bathtub, thereby facilitating the bathing process for an individual's caregivers. The combination bed and bathtub can be separated manually or with an electrically powered device. The combination bed and bathtub is safe, clean, durable, comfortable and easy to use.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. (canceled)

2. (canceled)

3. (canceled)

4. (canceled)

5. (canceled)

6. (canceled)

7. A combination bed and bathtub, said combination bed and bathtub to facilitate a bathing process utilized by those who cannot get out of bed, comprising:
a mattress with a left portion and a right portion;
a bathtub with a bottom disposed below said mattress, said left portion and said right portion are separated to utilize said bathtub; and
a sponge pad disposed on said bottom of bathtub, said sponge pad includes an absorbent quality.

8. The combination bed and bathtub according to claim 7, wherein said left portion and said right portion are manually separated.

9. The combination bed and bathtub according to claim 7, wherein said left portion and said right portion are manually retracted after being separated and utilized.

10. The combination bed and bathtub according to claim 7, wherein said sponge pad is made of light and removable sponge padding.

11. The combination bed and bathtub according to claim 7, wherein said combination bed and bathtub is utilized in a hospital.

12. The combination bed and bathtub according to claim 7, wherein said combination bed and bathtub is utilized in a nursing home.

13. The combination bed and bathtub according to claim 7, wherein said combination bed and bathtub is utilized by a caregiver.

14. A combination bed and bathtub, said combination bed and bathtub to facilitate a bathing process utilized by those who cannot get out of bed, comprising:
a mattress with a left portion and a right portion;
a bathtub with a bottom disposed below said mattress, said left portion and said right portion are separated to utilize said bathtub;
a sponge pad disposed on said bottom of bathtub, said sponge pad includes an absorbent quality; and
an electrically powered device to separate and retract said left portion and said right portion.

15. (canceled)

16. The combination bed and bathtub according to claim 14, wherein said left portion and said right portion are manually retracted after being separated and utilized.

17. The combination bed and bathtub according to claim 14, wherein said sponge pad is made of light and removable sponge padding.

18. The combination bed and bathtub according to claim 14, wherein said combination bed and bathtub is utilized in a hospital.

19. The combination bed and bathtub according to claim 14, wherein said combination bed and bathtub is utilized in a nursing home.

20. The combination bed and bathtub according to claim 14, wherein said combination bed and bathtub is utilized by a caregiver.
